(19) United States
(12) Patent Application Publication
(10) Pub. No.: US 2024/0148042 A1
(43) Pub. Date: May 9, 2024

(54) COOKING APPLIANCE AND METHOD OF OPERATING A COOKING APPLIANCE FOR ROASTING COFFEE BEANS

(71) Applicant: Haier US Appliance Solutions, Inc., Wilmington, DE (US)

(72) Inventors: Ju Chan Park, Seongnam-si (KR); Kyung-Ho Choo, Seongnam-si (KR); Hwanjae Yeo, Seoul-si (KR); Nayoung Lee, Seoul-si (KR)

(21) Appl. No.: 17/980,951

(22) Filed: Nov. 4, 2022

(51) Int. Cl. A23N 12/08; A23L 5/10; H05B 6/64

(52) U.S. Cl. CPC A23N 12/083; A23L 5/15; H05B 6/6473

(57) ABSTRACT

A cooking appliance includes a cabinet defining a cooking chamber; a first direct-heat source; a second direct-heat source; a convection heat source; and a controller operably coupled to the first heat source, the second heat source, and the convection heat source, the controller configured to perform a coffee roasting operation. The coffee roasting operation includes receiving an input command for the coffee roasting operation; obtaining a predetermined roasting profile among a plurality of roasting profiles in response to receiving the input command; determining a power level of at least one of the first direct-heat source, the second direct-heat source, or the convection heat source according to the obtained roasting profile; and initiating the coffee roasting operation after determining the power level of at least one of the first direct-heat source, the second direct-heat source, or the convection heat source.

### FIELD OF THE INVENTION

The present subject matter relates generally to cooking appliances, and more particularly to methods of performing coffee roasting operations in cooking appliances.

### BACKGROUND OF THE INVENTION

Conventional cooking appliances can perform multiple different cooking operations according to specific requests from users. Typically, one or more heat sources are located within the appliance to selectively provide heat to food items placed within the appliance. Recently, cooking appliances have included multiple features for performing a plurality of cooking operations on different types of food. Such features include different heat source types, air circulation, rotating plates or pans, and the like.

Some consumers prefer to personalize their consumption habits by preparing items within their own home. Recently, consumers have expressed desires to prepare certain beverages, such as coffee, at home. In some instances, consumers have even attempted to perform their own roasting operations at home. However, certain drawbacks exist to conventional methods of performing roasting operations. For instance, achieving an even and thorough cook can be challenging using conventional methods and instruments. Moreover, careful oversight is typically required throughout a cooking or roasting process to ensure desired results.

Accordingly, a cooking appliance that obviates one or more of the above-mentioned drawbacks would be beneficial. In particular, a method of operating a cooking appliance to perform accurate roasting operations (e.g., automatically, without direct user intervention or oversight) would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include a cabinet defining a cooking chamber; a first direct-heat source provided at a top of the cooking chamber; a second direct-heat source provided at a bottom of the cooking chamber; a convection heat source provided in the cooking chamber; and a controller operably coupled to the first heat source, the second heat source, and the convection heat source, the controller configured to perform a coffee roasting operation. The coffee roasting operation may include receiving an input command for the coffee roasting operation; obtaining a predetermined roasting profile among a plurality of roasting profiles in response to receiving the input command; determining a power level of at least one of the first direct-heat source, the second direct-heat source, or the convection heat source according to the obtained roasting profile; and initiating the coffee roasting operation after determining the power level of at least one of the first direct-heat source, the second direct-heat source, or the convection heat source.

In another exemplary embodiment of the present disclosure, a method of operating a cooking appliance is provided. The cooking appliance may include a first direct-heat source, a second direct-heat source, and a convection heat source. The method may include receiving an input command for a coffee roasting operation; obtaining a predetermined roasting profile among a plurality of roasting profiles in response to receiving the input command; determining a power level of at least one of the first direct-heat source, the second direct-heat source, or the convection heat source according to the obtained roasting profile; and initiating the coffee roasting operation after determining the power level of at least one of the first direct-heat source, the second direct-heat source, or the convection heat source.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a perspective view of the exemplary cooking appliance of FIG. 1, wherein the door is an open position.

FIG. 3 provides a sectional view of the exemplary cooking appliance of FIG. 2.

FIG. 4 provides a perspective view of a roasting assembly according to exemplary embodiments of the present disclosure.

FIG. 5 provides a flow chart illustrating a method of operating a cooking appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

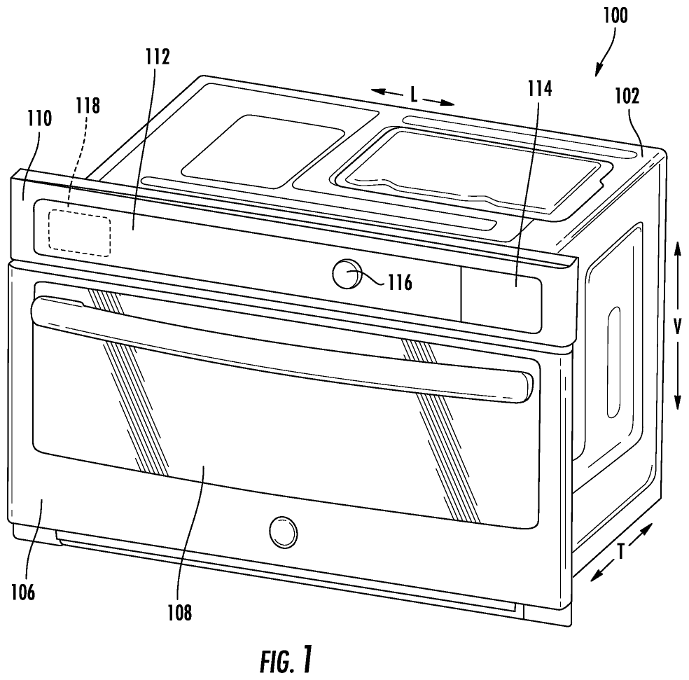

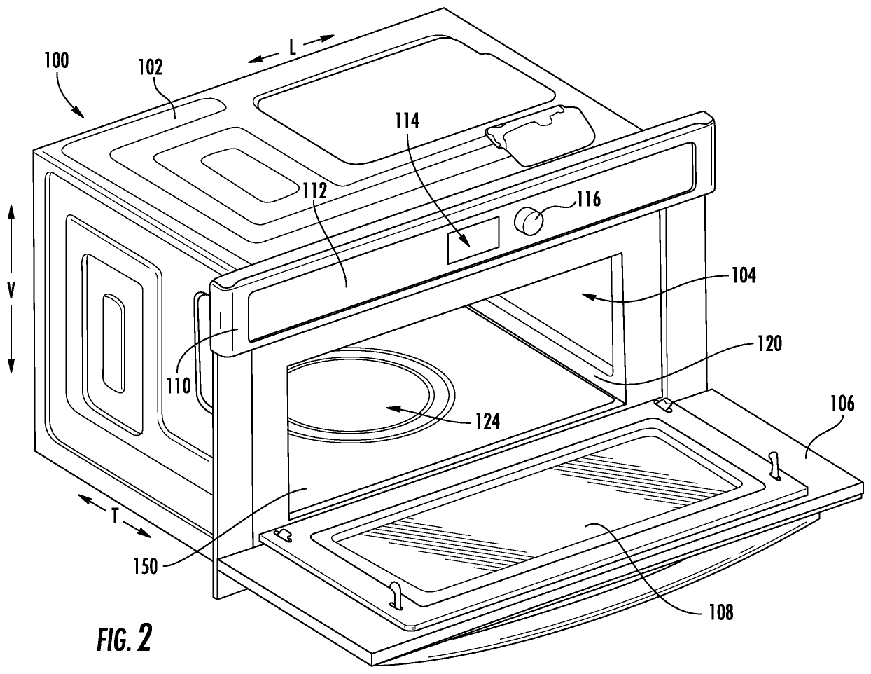

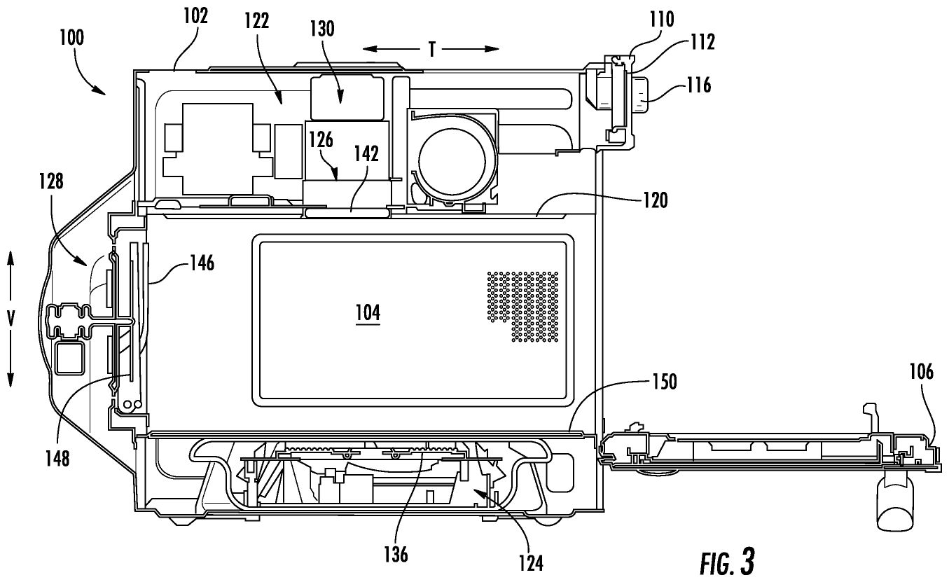

Turning now to the figures, FIGS. 1 through 3, provide various views of a cooking appliance 100 according to exemplary embodiments of the present disclosure. Specifically, FIGS. 1 and 2 provide perspective views of cooking appliance 100 having a door 106 in an open position and a closed position, respectively. FIG. 3 provides a side, sectional view of cooking appliance 100, wherein door 106 is in the open position.

Generally, cooking appliance 100 includes a housing or cabinet 102 that defines a mutually-orthogonal vertical direction V, lateral direction L, and transverse direction T. Within cabinet 102, cooking appliance 100 defines a cooking chamber 104 in which food items may be received. In some embodiments, a door 106 is rotatably mounted to move between the open position and the closed position. As shown, the open position permits access to cooking chamber 104 while the closed position restricts access to cooking chamber 104. A window in door 106 may be provided (e.g., for viewing food items in the cooking chamber 104). Additionally or alternatively, a handle may be secured to door 106 (e.g., to rotate therewith). The handle may be formed of plastic, for example, and may be injection molded.

In certain embodiments, cooking appliance 100 includes a control panel frame 110 on or as part of cabinet 102. A control panel 112 may be mounted within control panel frame 110. Generally, control panel 112 includes a display device 114 for presenting various information to a user. Control panel 112 may also include one or more input devices (e.g., tactile buttons, knobs, touch screens, etc.). In optional embodiments, the input devices of control panel 112 include a knob or dial 116. Selections may be made by rotating dial 116 clockwise or counter-clockwise, and when the desired selection is displayed, pressing dial 116. For example, multiple meal cook cycles and other cooking algorithms may be preprogrammed in or loaded onto a memory device of a controller 118 of cooking appliance 100 for many different food item types (e.g., pizza, fried chicken, French fries, potatoes, etc.), including simultaneous preparation of a group of food items of different food types comprising an entire meal. Instructions or selections may be displayed on display device 114. In optional embodiments, display device 114 may be used as an input device. For instance, display device 114 may be a touchscreen device, as is understood.

In exemplary embodiments, cabinet 102 of cooking appliance 100 includes an inner shell 120. Inner shell 120 of cabinet 102 delineates the interior volume of cooking chamber 104. Optionally, the walls of shell may be constructed using high reflectivity (e.g., 72% reflectivity) stainless steel.

Cooking appliance 100 may include multiple cooking modules. In particular, cooking appliance 100 may include a microwave module 122 and a lower heater module 124 mounted within cabinet 102. In additional or alternative embodiments, cooking appliance 100 includes an upper heater module 126 or a convection module 128.

Generally, microwave module 122 includes a magnetron 130 mounted within the cabinet 102 (e.g., above cooking chamber 104) and in communication (e.g., fluid or transmissive communication) with the cooking chamber 104 to direct microwave radiation or microwaves thereto. In other words, the microwave module 122 delivers microwave radiation into cooking chamber 104.

Below microwave module 122, lower heater module 124 may be mounted within cabinet 102. For instance, lower heater module 124 may include a heating coil 136 mounted below cooking chamber 104. The heating coil 136 may be, e.g., an induction heating coil or a resistive heating coil. The heating coil 136 may be in communication (e.g., transmissive communication) with cooking chamber 104 for heating objects, e.g., food items and/or cooking utensils, positioned within the cooking chamber 104. Accordingly, lower heater module 124 may be a direct-heat source. As such, lower heater module 124 may provide direct heat (e.g., conductive, radiative) to items provided within cooking chamber 104.

Lower heater module 124 may be selectively operable at varying power levels. In detail, heating coil 136 may be configured to emit or produce a variable amount of heat (e.g., into cooking chamber 104). Heating coil 136 may be operably connected with, e.g., a controller (described below). The controller may direct a predetermined amount of power (e.g., wattage) to heating coil 136 (e.g., according to a user-selected power level). For example, lower heater module 124 can be driven at a power level designated by a number (e.g., 1 to 10). The selected numerical power level may be associated with the expected heat output, the wattage input, or the like. In some embodiments, the numerical division of power levels is associated with a percentage power output by heating coil 136. Thus, referring to the example above, a power level of 1 out of 10 may equate to a 10% heat output of heating coil 136. Additionally or alternatively, the numerical division of power levels may equate to a predetermined duty cycle of heating coil 136. For example, a power level of 5 out of 10 equates to the heating coil 136 being activated for a first time interval and deactivated for a second time interval equal to the first time interval.

Upper heater module 126 may include one or more heating elements 142. For instance, upper heater module 126 may include one or more electric heating elements, such as a resistive heating element (e.g., sheathed resistive heater) or a radiant heating element (e.g., a halogen cooking lamp) in thermal communication with cooking chamber 104. Upper heater module 126 may be mounted within or above cooking chamber 104 or otherwise spaced apart from microwave module 122. Accordingly, upper heater module 126 may be a direct-heat source. As such, upper heater module 126 may provide direct heat (e.g., conductive, radiative) to items provided within cooking chamber 104 (e.g., in solo operation or in concert with lower heater module 124, etc.).

Upper heater module 126 may be selectively operable at varying power levels (e.g., similar to lower heater module 124). In detail, the one or more heating elements 142 may be configured to emit or produce a variable amount of heat (e.g., into cooking chamber 104). Heating element 142 may be operably connected with, e.g., the controller (described below). The controller may direct a predetermined amount of power (e.g., voltage, wattage) to heating element 142 (e.g., according to a user-selected power level). For example, upper heater module 126 can be driven at a power level designated by a number (e.g., 1 to 10). The selected numerical power level may be associated with the expected heat output, the wattage input, or the like. In some embodiments, the numerical division of power levels is associated with a percentage power output by heating element 142. Thus, referring to the example above, a power level of 1 out of 10 may equate to a 10% heat output of heating element 142. Additionally or alternatively, the numerical division of power levels may equate to a predetermined duty cycle of heating element 142. For example, a power level of 5 out of 10 equates to the heating element 142 being activated for a first time interval and deactivated for a second time interval equal to the first time interval.

Convection module 128 may include a sheathed heater 146 and a convection fan 148. Convection fan 148 is provided for blowing or otherwise moving air over sheathed heater 146 of convection module 128 and into cooking chamber 104 (e.g., for convection cooking).

Convection module 128 may be selectively operable at varying power levels (e.g., similar to upper and lower heater modules 124 and 126). In detail, heater 146 may be configured to emit or produce a variable amount of heat (e.g., into cooking chamber 104). Additionally or alternatively, fan 148 may be selectively operated at varying rotational speeds. Heater 146 may be operably connected with, e.g., the controller (described below). The controller may direct a predetermined amount of power (e.g., wattage) to heater 146 (e.g., according to a user-selected power level). For example, convection module 128 can be driven at a power level designated by a number (e.g., 1 to 10). The selected numerical power level may be associated with the expected heat output, the wattage input, or the like. In some embodiments, the numerical division of power levels is associated with a percentage power output by heater 146. Thus, referring to the example above, a power level of 1 out of 10 may equate to a 10% heat output of heater 146. Additionally or alternatively, the numerical division of power levels may equate to a predetermined duty cycle of heater 146. For example, a power level of 5 out of 10 equates to the heater 146 being activated for a first time interval and deactivated for a second time interval equal to the first time interval.

The specific heating elements of upper and lower heater modules 126 and 124, convection module 128, and magnetron 130 of microwave module 122 can vary from embodiment to embodiment, and the elements and system described above are exemplary only. For example, the upper heater module 126 or convection module 128 can include any combination of heaters including combinations of halogen lamps, ceramic lamps, or sheathed heaters.

As shown, cooking appliance 100 may include a controller 118. Controller 118 of cooking appliance 100 may include one or more processor(s) and one or more memory device(s). The processor(s) of controller 118 may be any suitable processing device, such as a microprocessor, microcontroller, integrated circuit, or other suitable processing device. The memory device(s) of controller 118 may include any suitable computing system or media, including, but not limited to, non-transitory computer-readable media, RAM, ROM, hard drives, flash drives, or other memory devices. The memory device(s) of controller 118 can store information accessible by the processor(s) of controller 118 including instructions that can be executed by the processor(s) of controller 118 in order to execute various cooking operations or cycles (e.g., a meal cook cycle). As mentioned above, controller 118 is communicatively coupled with various operational components of cooking appliance 100, such as components of microwave module 122, upper heater module 126, lower heater module 124, convection module 128, or control panel 112 (e.g., display device 114 or dial 116), the various control buttons, etc. Input/output (“I/O”) signals may be routed between controller 118 and control panel 112 as well as other operational components of cooking appliance 100. Controller 118 can execute and control cooking appliance 100 in various cooking operations or cycles, such as precision cooking, which includes meal cook, microwave, induction, or convection/bake modes.

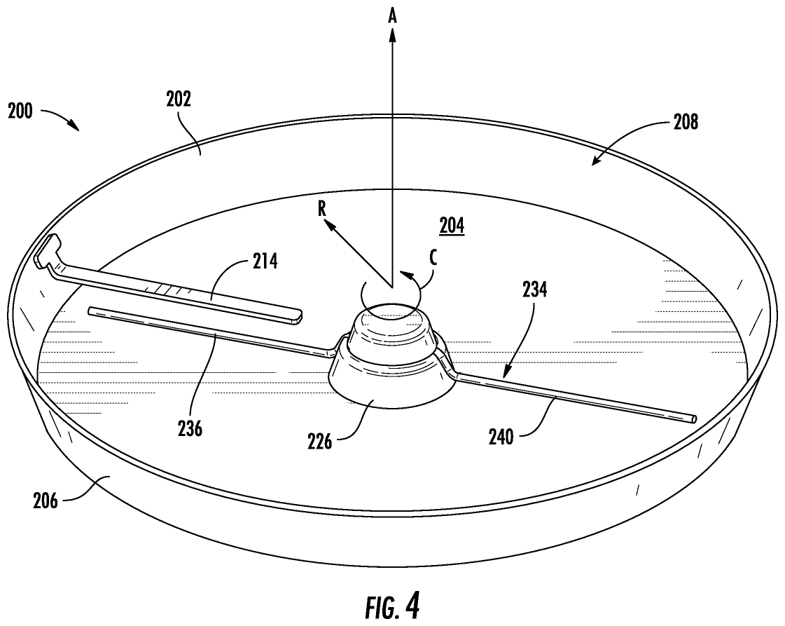

Referring now generally to FIG. 4, a roasting assembly 200 may be configured to be removably mounted within the cooking appliance, such as within the cooking chamber thereof, such as within cooking chamber 104 of cooking appliance 100 as described above. As is generally understood by those of ordinary skill in the art, the cooking appliance, such as a microwave oven appliance, e.g., a microwave-only oven appliance with no other heating modules, or a cooking appliance with other or additional heating modules, e.g., heating lamps, convection module, etc., as well as or instead of the microwave module, may include a turntable or rotating platter which can be removably mounted therein. The structure and function of such turntables are well understood by those of ordinary skill in the art and, as such, are not shown or further described herein for the sake of clarity and concision. When the turntable is removed, the roasting assembly 200 of the present disclosure may be installed in its place, e.g., on a ring assembly within the cooking chamber 104 of the cooking appliance 100. Roasting assembly 200 may define an axial direction A, a radial direction R perpendicular to the axial direction A, and a circumferential direction C extending around the axial direction A. In some embodiments, the axial direction A may be generally parallel to the vertical direction V, e.g., when the roasting assembly 200 is mounted in the cooking appliance 100.

Turning now specifically to FIG. 4, the roasting assembly 200 may include a pan 202. Pan 202 may include a bottom wall 204 and at least one side wall 206, such as a single curved side wall 206 as in the illustrated embodiment, or multiple linear side walls in additional embodiments. Pan 202, such as the walls 204 and 206 thereof, may define an internal volume 208. For example, food items, such as items to be roasted (e.g., coffee beans), may be selectively placed in the internal volume 208 of pan 202 during a cooking operation. Side wall 206 of pan 202 may include an outer surface facing away from the internal volume 208 and an inner surface that is generally parallel to and opposite the outer surface, e.g., the inner surface faces in an opposite direction from the outer surface, such as the inner surface faces the internal volume 208 of the pan 202. In some embodiments, the roasting assembly 200 may also include a stirrer bar 214. The stirrer bar 214 may be mounted to the pan 202, such as to the side wall 206, such as to the inner surface of side wall 206 of pan 202. The pan 202 may also include an aperture through bottom wall 204, such as at about the geometric center of the bottom wall 204. A threaded post of a rotating body assembly may extend through the aperture and into the internal volume 208 when the roasting assembly 200 is assembled.

In some embodiments, a rotating body assembly is provided. The rotating body assembly may include a rotating cap 226. Rotating cap 226 may be frustoconical in shape. Rotating cap 226 may include a groove, such as in an upper end of the rotating cap 226. A stirrer rod 234 may be received in the groove, e.g., the stirrer rod 234 may include a first end portion 236 and a second end portion 240. In some embodiments, a central portion of the stirrer rod 234 is received in the groove of the rotating cap 226. For example, the stirrer rod may extend from a first end defined at the terminus of the first end portion 236 to a second end defined at the terminus of the second end portion 240. Each of the first end portion 236 and the second end portion 240 may be linear, whereas the central portion may be articulated. For example, the groove 230 in the rotating cap 226 may include one or more bends or arcs, and the central portion of stirrer rod 234 may have a corresponding shape to promote the central portion being received in and fitted with the groove.

When rotating, e.g., when roasting assembly 200 is driven by a motor, wheels of the ring assembly (e.g., positioned within cooking chamber 104 on floor 150) may impart a rotation to the pan 202. Thus, stirrer rod 234 and pan 202 may rotate at different speeds. For example, pan 202 may rotate at about three-quarters or less of the speed of the stirrer rod 234. Thus, due to the differential in the rotation speeds of pan 202 and stirrer rod 234 within the internal volume 208 of pan 202, stirrer rod 234 may rotate relative to pan 202, and each end portion 236 and 240 of stirrer rod 234 will periodically pass under stirrer bar 214, whereupon stirrer rod 234 and stirrer bar 214 may cooperatively enhance mixing and/or turning of food items, e.g., coffee beans, being heated, e.g., roasted, within the roasting assembly 200.

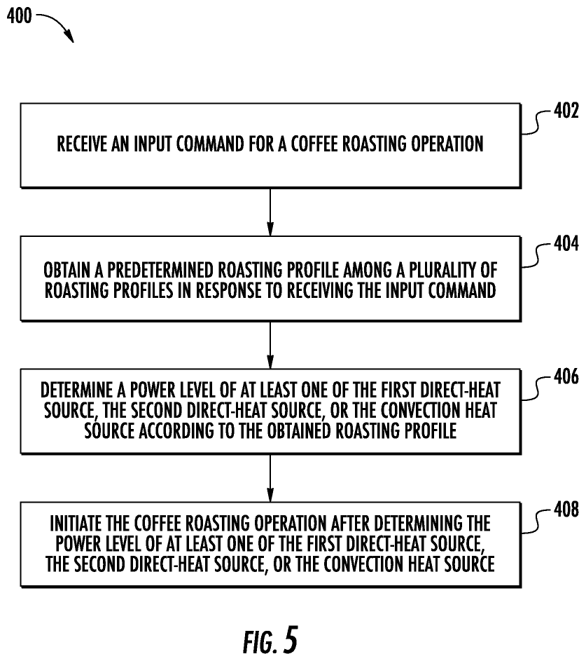

Now that the general descriptions of an exemplary appliance have been described in detail, a method 400 of operating an appliance (e.g., cooking appliance 100) will be described in detail. Although the discussion below refers to the exemplary method 400 of operating cooking appliance 100, one skilled in the art will appreciate that the exemplary method 400 is applicable to any suitable domestic appliance capable of performing a cooking or roasting operation (e.g., such as a cooktop, an oven, a stand-alone burner, etc.). In exemplary embodiments, the various method steps as disclosed herein may be performed by controller 118 and/or a separate, dedicated controller. FIG. 5 provides a flow chart illustrating a method of operating a cooking appliance.

Advantageously, methods in accordance with the present disclosure provide customizable and precise coffee roasting operations for home use in producing roasted coffee beans. As will be explained, a plurality of factors related to the coffee roasting operation may be altered, adjusted, saved, and implemented to specific roasting patterns to readily create a desired roasting level of coffee beans. Home production of roasted coffee beans may be performed via the method(s) presented herein.

At step 402, method 400 may include receiving an input command for a coffee roasting operation. For instance, the input command may be a request from a user to perform a coffee roasting operation within the appliance. The input command may be received directly on the appliance (e.g., via a user interface). The user may select a predetermined coffee roasting operation among a plurality of coffee roasting operations. For example, one or more specific (e.g., customized) coffee roasting operations can be stored on board the appliance (e.g., within a memory). Depending on a particular style of roast desired, the user may select a particular operation.

Additionally or alternatively, the input command for the coffee roasting operation may be received remotely. In detail, a mobile device (e.g., a mobile phone) may be remotely connected with the appliance (e.g., via a wireless connection). The mobile device may communicate with the appliance via a mobile application (app). Within the app, for instance, the user may submit the input command. Accordingly, via the remote connection, the appliance may receive the input command.

At step 404, method 400 may include obtaining a predetermined roasting profile among a plurality of roasting profiles in response to receiving the input command. As mentioned above a plurality of individual roasting operations may be stored. Each roasting operation may include a specific roasting profile. Accordingly, a plurality of predetermined roasting profiles may be available for selection (e.g., by the user). The plurality of predetermined roasting profiles may include a dark roast profile, a medium roast profile, a light roast profile, and one or more custom roast profiles.

Each of the predetermined roasting profiles may include particular features related to the heat sources within the appliance, such as a first heat source, a second heat source, and a convection heat source (e.g., lower heater module 124, upper heater module 126, convection module 128, etc.). In detail, the roasting profiles may include specific settings for each of the heat sources. As described above, each of the first heat source, the second heat source, and the convection heat source may be directed or operated at one of a plurality of power levels. Accordingly, with regard to the individual roasting profiles, each of the heat sources may include a predetermined power level.

Each respective roasting profile may include a cooking time. For instance, the cooking time may be or include a length of time or time interval for which each of the heat sources are driven. The cooking time may apply to each of the heat sources collectively. For example, each of the first heat source, the second heat source, and the convection heat source has the same cooking time (e.g., for the dark roast profile, the light roast profile, etc.). However, according to some embodiments, the cooking time may vary among the heat sources within a single roasting profile. For instance, according to one or more custom profiles, the first and second heat sources may be driven for a first cooking time while the convection heat source may be driven for a second cooking time different from the first cooking time. In one example, the second cooking time is greater than the first cooking time. Advantageously, different roasting profiles may produce different styles of food items (e.g., coffee beans) according to a desired color, style, taste, or the like.

The cooking times may additionally or alternatively vary among each roasting profile. For instance, the cooking time of the dark roast profile may be different from the cooking time of the medium roast profile and the light roast profile. In other words, each of the individual roast profiles may have a mutually exclusive cooking time. According to some embodiments, the cooking time is between about 13 minutes and about 18 minutes. The light roast profile may include a cooking time of between about 13 minutes and about 15 minutes. The medium roast profile may include a cooking time of between about 14 minutes and about 16 minutes. The dark roast profile may include a cooking time of between about 15 minutes and about 17 minutes. Additionally or alternatively, the one or more custom profiles may include custom cooking times. For instance, in establishing a custom profile, the user may manually enter (e.g., via the user interface) a custom cooking time.

At step 406, method 400 may include determining a power level of at least one of the first heat source, the second heat source, or the convection heat source according to the obtained roasting profile. In detail, within each respective roasting profile (e.g., the dark roast profile, the medium roast profile, the light roast profile, etc.), particular individual power levels may be set for each heat source. Thus, within an individual roast profile, the first heat source may be set to a first predetermined power level (e.g., between 1 and 10 as described above), the second heat source may be set to a second predetermined power level, and the convection heat source may be set to a third predetermined power level.

According to some embodiments, each of the light roast profile, the medium roast profile, and the dark roast profile have identical power levels. In detail, the power level of the first heat source in the dark roast profile may be identical to the power level of the first heat source in each of the medium roast profile and the light roast profile. Similarly, the power level of the second heat source in the dark roast profile may be identical to the power level of the second heat source in each of the medium roast profile and the light roast profile. Moreover, the power level of the convection heat source in the dark roast profile may be identical to the power level of the convection heat source in each of the medium roast profile and the light roast profile. Accordingly, each of the dark roast profile, the medium roast profile, and the light roast profile may have different cooking times (e.g., for each of the first, second, and convection heat sources) while driving the heating elements at identical power levels for each roast profile.

At step 408, method 400 may include initiating the coffee roasting operation after determining the power level of at least one of the first heat source, the second heat source, or the convection heat source. In detail, upon retrieving the predetermined power levels for each respective heat source (or determining an appropriate power level for each heat source), the method 400 may begin performing the coffee roasting operation. Thus, at least part of the initiation of the coffee roasting operation may include activating or driving one or more of the first heat source, the second heat source, or the convection heat source. For instance, each of the heat sources may receive power (e.g., electric power or voltage) from the power source of the appliance to produce heat at the determined power level.

As mentioned above, the coffee roasting operation may include driving a rotation of a pan (e.g., pan 200) and a stirrer rod (e.g., stirrer rod 234). In detail, a motor provided within the appliance may be activated to provide a rotational input to the pan and/or the stirrer rod. The pan may be rotated in a first direction (e.g., clockwise or counterclockwise). In some embodiments, the pan is rotated each of the first direction and a second direction opposite the first direction. Additionally or alternatively, the stirrer rod may be rotated in the first direction. For instance, the stirrer rod may be rotated at a different rotational speed (e.g., rotations per minute or RPM) than the pan. Moreover, the stirrer rod may be rotated in an opposite direction from the pan. Further, each of the pan and the stirrer rod may be continuously rotated throughout the coffee roasting operation (e.g., while each of the heat sources are activated). Thus, in addition to each of the first heat source, the second heat source, and the convection heat source being activated at the predetermined power levels, the roasting pan may be rotated. Further, in some embodiments, one or more fans (e.g., the convection fan within the convection heat source) may be activated to encourage airflow within the cooking chamber. Additionally or alternatively, an internal timer may be initiated to track the cooking time associated with the selected coffee roasting profile.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance, comprising:
a cabinet defining a cooking chamber;
a first direct-heat source provided at a top of the cooking chamber;
a second direct-heat source provided at a bottom of the cooking chamber;
a convection heat source provided in the cooking chamber; and
a controller operably coupled to the first heat source, the second heat source, and the convection heat source, the controller configured to perform a coffee roasting operation, the coffee roasting operation comprising:
receiving an input command for the coffee roasting operation;
obtaining a predetermined roasting profile among a plurality of roasting profiles in response to receiving the input command;
determining a power level of at least one of the first direct-heat source, the second direct-heat source, or the convection heat source according to the obtained roasting profile; and
initiating the coffee roasting operation after determining the power level of at least one of the first direct-heat source, the second direct-heat source, or the convection heat source.

2. The cooking appliance of claim 1, wherein the plurality of roasting profiles comprises a dark roast profile, a medium roast profile, a light roast profile, and one or more custom roast profiles.

3. The cooking appliance of claim 2, wherein the one or more custom profiles comprise predetermined power levels of each of the first direct-heat source, the second direct-heat source, and the convection heat source.

4. The cooking appliance of claim 3, wherein each of the dark roast profile, the medium roast profile, and the light roast profile have identical power levels for the first direct-heat source, the second direct-heat source, and the convection heat source.

5. The cooking appliance of claim 1, wherein the power level of the first direct-heat source is adjustable between 1 and 10, the power level of the second direct-heat source is adjustable between 1 and 10, and the power level of the convection heat source is adjustable between 1 and 10.

6. The cooking appliance of claim 1, wherein the predetermined roasting profile comprises a cooking time for which the first direct-heat source, second direct-heat source, and convection heat source are activated.

7. The cooking appliance of claim 6, wherein the cooking time is between 13 minutes and 18 minutes.

8. The cooking appliance of claim 1, wherein initiating the coffee roasting operation comprises:
activating each of the first direct-heat source, the second direct-heat source, and the convection heat source at the determined power level, wherein the first direct-heat source and the second direct-heat source are activated at the same power level.

9. The cooking appliance of claim 1, wherein the first direct-heat source is one of a radiative heat source or a conductive heat source, and the second direct-heat source is one of a radiative heat source or a conductive heat source.

10. The cooking appliance of claim 1, further comprising a roasting assembly provided within the cooking chamber, the roasting assembly comprising:
a pan provided in the cooking chamber, the pan being rotatable about a first direction and defining a receiving space;
a stirrer rod provided within the receiving space of the pan, the stirrer rod being rotatable with respect to the pan.

11. A method of operating a cooking appliance, the cooking appliance comprising a first direct-heat source, a second direct-heat source, and a convection heat source, the method comprising:
receiving an input command for a coffee roasting operation;
obtaining a predetermined roasting profile among a plurality of roasting profiles in response to receiving the input command;
determining a power level of at least one of the first direct-heat source, the second direct-heat source, or the convection heat source according to the obtained roasting profile; and
initiating the coffee roasting operation after determining the power level of at least one of the first direct-heat source, the second direct-heat source, or the convection heat source.

11. The method of claim 10, wherein the plurality of roasting profiles comprises a dark roast profile, a medium roast profile, a light roast profile, and one or more custom roast profiles.

12. The method of claim 11, wherein the one or more custom profiles comprise predetermined power levels of each of the first direct-heat source, the second direct-heat source, and the convection heat source.

13. The method of claim 10, wherein the power level of the first direct-heat source is adjustable between 1 and 10, the power level of the second direct-heat source is adjustable between 1 and 10, and the power level of the convection heat source is adjustable between 1 and 10.

14. The method of claim 10, wherein the predetermined roasting profile comprises a cooking time for which the first direct-heat source, second direct-heat source, and convection heat source are activated.

15. The method of claim 14, wherein the cooking time is between 13 minutes and 18 minutes.

16. The method of claim 10, wherein initiating the coffee roasting operation comprises:
activating each of the first direct-heat source, the second direct-heat source, and the convection heat source at the determined power level.

17. The method of claim 10, wherein the first direct-heat source is one of a radiative heat source or a conductive heat source, and the second direct-heat source is one of a radiative heat source or a conductive heat source.

18. The method of claim 10, wherein the cooking appliance further comprises a roasting assembly, the roasting assembly comprising:
a pan provided in a cavity of the cooking appliance, the pan being rotatable about a first direction and defining a receiving space;
a stirrer rod provided within the receiving space of the pan, the stirrer rod being rotatable with respect to the pan.
